(19) United States
(12) Patent Application Publication
(10) Pub. No.: US 2025/0379010 A1
(43) Pub. Date: Dec. 11, 2025

(54) PUSHBUTTON FOR CAPSULE-SHAPED SPEAKER

(71) Applicant: SAGEMCOM BROADBAND SAS, BOIS-COLOMBES (FR)

(72) Inventors: Jérémy STANGALINI, BOIS-COLOMBES (FR); Radu NEDELCU, BOIS-COLOMBES (FR); Arnaud COFFINET, BOIS-COLOMBES (FR)

(21) Appl. No.: 19/233,540

(22) Filed: Jun. 10, 2025

(30) Foreign Application Priority Data
Jun. 11, 2024 (FR) FR2406195

(51) Int. Cl. H01H 13/52; H01H 13/04; H01H 13/10

(52) U.S. Cl. CPC H01H 13/52; H01H 13/04; H01H 13/10

(57) ABSTRACT

A pushbutton, comprising:
an actuating member;
a base, flexible and generally flat in shape, comprising a first hole and a rib that extends from a first face of the base around the first hole;
a diaphragm, elastic, having a first end connected to a first end of the actuating member and a second end connected to the first face of the base between the first hole and the rib;
the pushbutton being arranged in such a manner that, when pressure is exerted on a second end of the actuating member, the diaphragm deforms and the actuating member undergoes a translational movement along the axis towards the base, and in such a manner that, when the pressure ceases, the actuating member returns to its initial position.

The invention relates to the field of pushbuttons for electrical equipment.

### BACKGROUND

It is considered to design a speaker having curved external surfaces, and in particular a speaker with a “capsule” shape. This speaker can optionally comprise a support enabling to position it vertically on a flat surface (of a piece of furniture, for example). The speaker can also be placed directly in a horizontal position on this flat surface.

The speaker is, for example, a “satellite” speaker intended to be connected to a device configured to broadcast sound content, such as a set-top box (STB). The set-top box itself possibly integrates one or more loudspeakers.

Such a speaker typically comprises a sound box. This is a waterproof casing in which one or more loudspeakers are integrated. The casing can be constituted of a single part or can be obtained by the assembly of a plurality of parts.

The sound box, which also has a shape close to that of a capsule, defines a technical volume necessary for the implementation of the technical functions of the audio part of the speaker. The box delimits the acoustic volume, and integrates the loudspeakers and the connections for bringing the audio signals to the loudspeakers. This technical volume can also be used to integrate components implementing “transversal” functions: control, communication (Wi-Fi interface, for example), electrical power supply, etc.

The speaker also comprises one or more protective parts mounted on the box and which cover (at least) the loudspeaker diaphragms to protect them from external aggressions. These protective parts comprise holes to let out the sounds generated by the loudspeakers. These protective parts also enable to give the speaker a certain aesthetic appearance. A fabric sometimes covers the protective parts in full or in part, which then also fulfil the support function of said fabric.

A speaker conventionally comprises one or more buttons which enable the user to interact with the speaker.

For example, it is known to use a mechanical button of the touch switch type (tact switch), or else of the slide switch type (slider). For example, pushbuttons are known which are mounted on a printed circuit integrated into a speaker, and which comprise an actuating member (movable part of the button) which passes through the casing of the speaker and which is accessible from outside the speaker.

The buttons of the prior art have a certain number of disadvantages in the case of a speaker, and in particular a speaker with curved external surfaces.

Most of these buttons have an actuating member which is relatively short. However, due to the shape of the speaker, the printed circuit must be moved back and away from the external surface of the speaker. The actuating member of most buttons of the prior art, is not long enough to reach the external surface of the speaker.

Furthermore, the length of the actuating member of the buttons of the prior art, is limited to a list of standard dimensions, predefined by the manufacturer, and therefore, do not enable customisation of the button. However, the capsule speaker here, has a very particular design which is not compatible with most buttons on the market.

Furthermore, the sound box of the speaker must be perfectly sealed acoustically. The use of buttons of the prior art requires adding additional parts or components to ensure the sealing of the box (seal, adhesive foam, bearing elements, etc.). These parts increase the cost and complexity of the assembly.

In addition, the buttons of the prior art are generally manufactured with one or more rigid materials, such as polyamide. They therefore, vibrate strongly when they are subjected to the vibrations of the speaker in operation.

These buttons themselves, and their actuating member in particular, are also sources of vibrations (in the button itself or between the actuating member and the adjacent parts and components).

### OBJECT

The object of the invention is to design a pushbutton:
which can be integrated into a speaker (or any other equipment) having curved external surfaces;
which can be easily customised;
which is robust and compact;
which limits vibrations;
whose interface with the rest of the speaker is sealed, without the need for additional components.

### SUMMARY

In order to achieve this aim, a pushbutton is proposed, comprising:
an actuating member, elongate in shape along an axis;
a base, flexible and generally flat, that extends perpendicularly to the axis, and which comprises a first hole and a rib that extends from a first face of the base around the first hole;
a diaphragm, elastic, having a first end connected to a first end of the actuating member and a second end connected to the first face of the base between the first hole and the rib;
the pushbutton being arranged in such a manner that, when pressure is exerted on a second end of the actuating member, the diaphragm deforms and the actuating member undergoes a translational movement along the axis towards the base, and in such a manner that, when the pressure ceases, the actuating member returns to its initial position.

The pushbutton is very simple. It can be a one-piece part, both compact and robust. The manufacturing method of this part is very simple and therefore, the button is easily customisable.

The elongated shape of the actuating member enables the button to cooperate with a contact device mounted on a printed circuit which is significantly away from the external surface of the speaker. The button is therefore, compatible with a speaker, or any other electrical equipment, which has curved external surfaces.

The rib of the base of the pushbutton can be crushed against an inner surface of the sound box of the speaker (or more generally, of the casing of an electrical equipment), which enables to ensure the acoustic sealing of the box. No additional parts are required to ensure this sealing.

The elastic mechanical characteristics of the button enable to limit vibrations.

In addition, a pushbutton as previously described is proposed, comprising a first electrically conductive pad, which is positioned on a face of the first end of the actuating member.

In addition, a pushbutton as previously described is proposed, comprising at least a second, electrically conductive pad, which is positioned on a second face of the base.

In addition, a pushbutton as previously described is proposed, comprising at least one electrically conductive ring, which is positioned on a second face of the base and which is centred on the axis.

In addition, a pushbutton as previously described is proposed, comprising at least one protrusion that extends from the base, radially, outward from it.

In addition, a pushbutton as previously described is proposed, in which the actuating member, the base and the diaphragm form a one-piece part made of elastomer.

In addition, a pushbutton as previously described is proposed, comprising at least one evacuation device enabling to evacuate air from an inner volume of the pushbutton delimited by the diaphragm and by a plane in which extends a second face of the base, the evacuation device comprising a second hole passing through the base and positioned between the second end of the diaphragm and the rib, and a duct connecting the inner volume to the second hole.

In addition, an equipment comprising a casing, a printed circuit integrated in the casing, fixed to an inner surface of the casing, and on which a first contact device is located, and a pushbutton as previously described is proposed, which is also integrated in the casing, the equipment being arranged such that the base of the pushbutton is located between the printed circuit and the inner surface of the casing, the first face of the base is in contact with said inner surface of the casing and a second face of the base is in contact with the printed circuit, the printed circuit presses on the second face of the base such that the rib is crushed against the inner surface of the casing, the first contact device is positioned in the first hole of the base, the actuating member extends through the casing, and a second end of the actuating member is accessible from the outside of the casing such that when a pressure is exerted on the second end of the actuating member, the diaphragm deforms and the first end of the actuating member comes into contact with the first contact device, and such that when the pressure ceases, the actuating member returns to its initial position, the equipment further comprising a processing unit connected to the first contact device and arranged to control a predefined action when the first end of the actuating member comes into contact with the first contact device.

In addition, an equipment as previously described is proposed, in which the inner surface of the casing comprises a groove in which the rib of the first face of the base of the pushbutton is positioned.

In addition, an equipment as previously described is proposed, the first contact device comprising at least two conductive track portions printed on the printed circuit, the first pad being arranged to short-circuit the two conductive track portions when the first end of the actuating member comes into contact with the two conductive track portions.

In addition, an equipment as previously described is proposed, in which the printed circuit comprises at least a second contact device arranged to detect at least a second, electrically conductive pad, which is optionally present on a second face of the base of the pushbutton, the processing unit being arranged to configure the equipment depending on a number and/or a position of second detected pads.

In addition, an equipment as previously described is proposed, in which the printed circuit comprises at least one third contact device arranged to detect at least one protrusion, optionally present by extending from the base of the pushbutton, radially, outward from it, the processing unit being arranged to configure the equipment depending on a number and/or a position of detected protrusions.

In addition, an equipment as previously described is proposed, in which the equipment is a speaker.

In addition, an equipment as previously described is proposed, in which the configuration of the speaker consists in giving it a position in a multichannel audio system.

The invention will be better understood in light of the following description of a particular and non-limiting embodiments of the invention.

### BRIEF DESCRIPTION OF THE DRAWINGS

Reference will be made to the accompanying drawings, among which:

FIG. 1 is a perspective view of a speaker integrating a pushbutton;

FIG. 2 is an exploded view of the speaker of FIG. 1;

FIG. 3 is a cross-sectional view of the speaker of FIG. 1;

FIG. 4 is a cross-sectional view of the button positioned inside the speaker, and of the printed circuit;

FIG. 5 is a perspective view of the pushbutton positioned horizontally;

FIG. 6 is a perspective view of the pushbutton positioned vertically;

FIG. 7 shows a conductive track of a first contact device;

FIG. 8 shows a detection circuit according to a first embodiment, connected to the first contact device;

FIG. 9 shows a detection circuit according to a second embodiment, connected to the first contact device;

FIG. 10 is a view similar to that of FIG. 5, according to another embodiment of the pushbutton;.

FIG. 11 is a view of the second face of the base of the button, which is provided with a protrusion;

FIG. 12 shows side views of the speaker and its support, before and after mounting the support on the speaker, according to a “table stand” mounting configuration;

FIG. 13 is a Figure similar to FIG. 12, according to a “wall mount” configuration;

FIG. 14 shows a front view of the support in the “table stand” configuration, and a front view of the support in the “wall mount” configuration;

FIG. 15 shows views of the support according to a particular embodiment, before and after folding the curved portion;

FIG. 16 plurality of views illustrating the support according to a particular embodiment, in which the curved portion is headed on the base.

### DETAILED DESCRIPTION

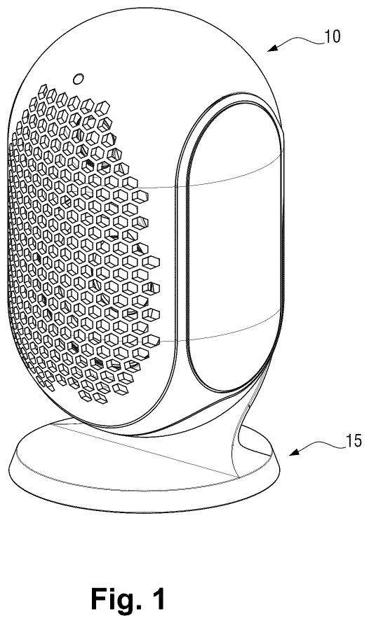

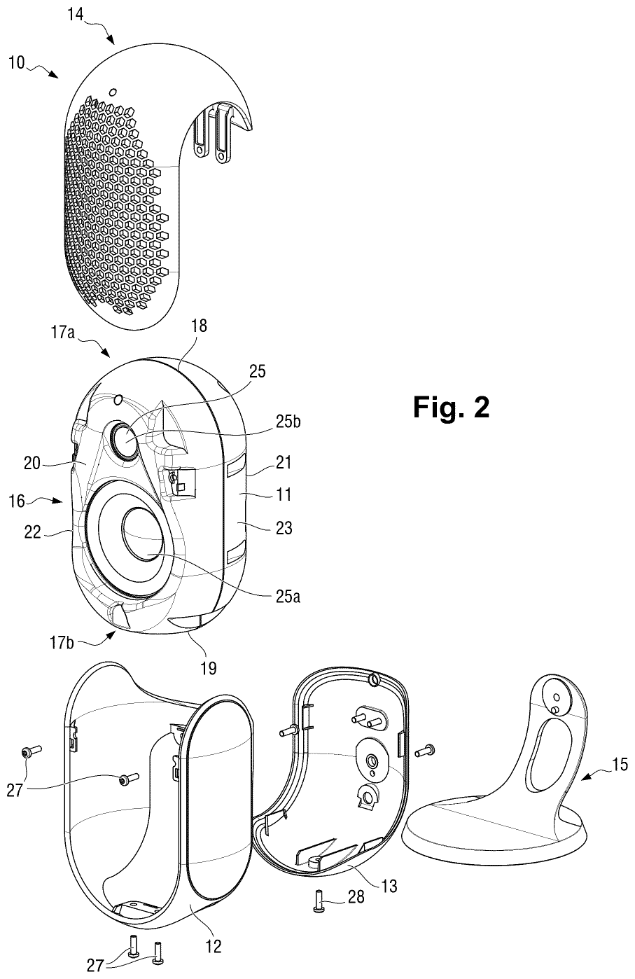

With reference to FIGS. 1 and 2, the speaker 10 is here a portable speaker which comprises curved external surfaces and more precisely, has the shape of a “capsule”. The speaker 10 comprises:
a sound box 11;
a first shell 12;
a second shell 13;
a protective part 14;
a support 15.

In the nominal operating position, the speaker 10 is positioned vertically. All the positioning terms used here must be interpreted considering that the speaker 10 is in this nominal operating position.

The sound box 11 comprises a central portion 16 and two ends 17a, 17b, hemispherically-shaped.

The end 17a forms a upper face 18 of the box 11. The end 17b forms a lower face 19 of the box 11. The central part 16 comprises side faces comprising a front face 20, a rear face 21, a left face 22 and a right face 23 of the box 11.

The sound box 11 also has the general shape of a capsule, but which is flattened at its front face 20 and its rear face 21. All the external surfaces of the box 11 are curved surfaces.

Two loudspeakers 25 are here, integrated in the sound box 11.

The loudspeaker 25a is a Woofer type loudspeaker. This is a loudspeaker which reproduces low frequencies, for example, of between 100 Hz and 2 kHz. The term woofer is also used to designate this type of loudspeaker.

The loudspeaker 25b is a Tweeter type speaker. This is a loudspeaker that reproduces high frequencies, for example, of between 2 kHz and 20 kHz. The term treble loudspeaker is also used to designate this type of loudspeaker. The diameter of the diaphragm of the loudspeaker 25a is greater than the diameter of the diaphragm of the loudspeaker 25b.

The loudspeaker 25a is integrated in the sound box 11 such that its diaphragm is positioned, for example, at a lower portion of the front face 20 of the sound box 11. The loudspeaker 25b is integrated in the sound box 11 such that its diaphragm is positioned, for example, at an upper portion of the front face 20 of the sound box 11.

The first shell 12 aims to protect the left face 22 and the right face 23 of the box 11. The first shell 12 is fixed to the box by screws 27.

The second shell 13 aims to protect the rear face 21 and the lower face 19 of the box 11. The second shell 13 is fixed to the box by screws 28.

The protective part 14 aims in particular to protect the front face 20 and the upper face 18 of the box 11.

The support 15 will be described below in this description.

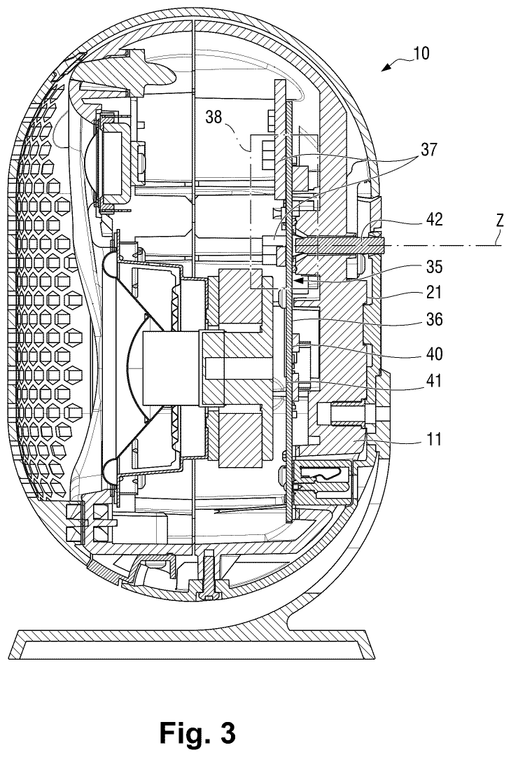

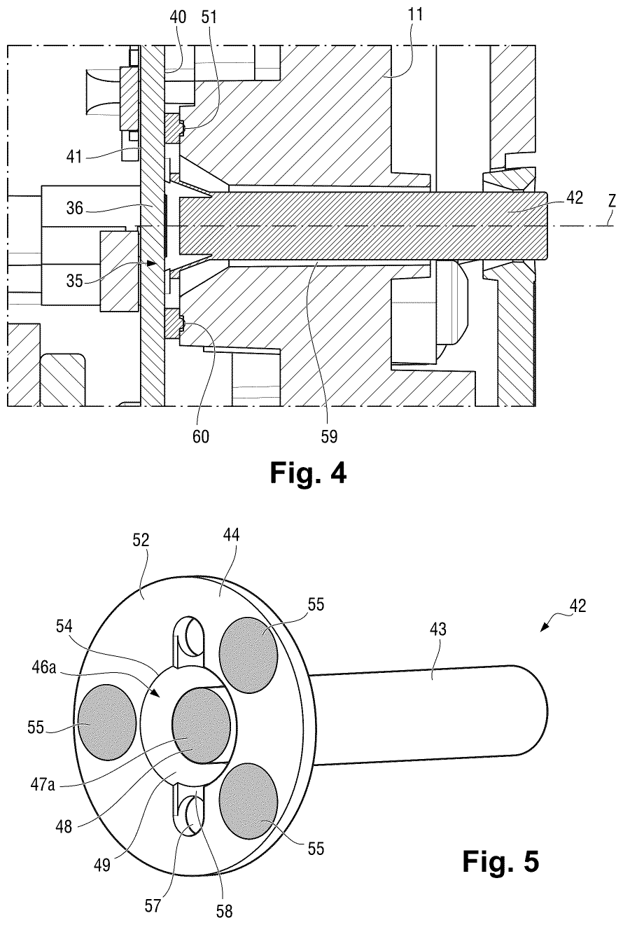

With reference to FIGS. 3 and 4, the speaker 10 further integrates an electrical board 35 which comprises a printed circuit 36 and electronic components 37 (and software) mounted on the printed circuit 36.

These electronic components 37 comprise a processing unit 38. The processing unit 38 comprises at least one processing component 5a, which is, for example, a “general” processor, a processor specialising in the processing of the signal (or DSP, for Digital Signal Processor), a microcontroller, or a programmable logic circuit, such as an FPGA (Field Programmable Gate Arrays) or an ASIC (Application Specific Integrated Circuit). The processing unit 38 also comprises one or more memories 5b, connected to or integrated in the processing component 5a. At least one of these memories forms a computer-readable storage medium, on which is recorded at least one computer program, comprising instructions which lead the processing unit 38 to execute the steps of the configuration method which is described below.

The electronic components 37 also comprise audio components, communication components, etc.

The printed circuit 36 is integrated in the sound box 11. It comprises a first face 40 which is oriented towards the rear face 21 of the box 11 (and which is parallel to it), and a second face 41 which is oriented towards the front face 20 of the box 11.

The speaker 10 also integrates a pushbutton 42 which enables to control at least one predefined action carried out by the speaker 10. This predefined action consists, for example, in turning the speaker 10 on/off, but can also consist in configuring the speaker in a particular way, or in carrying out a Bluetooth pairing, etc.

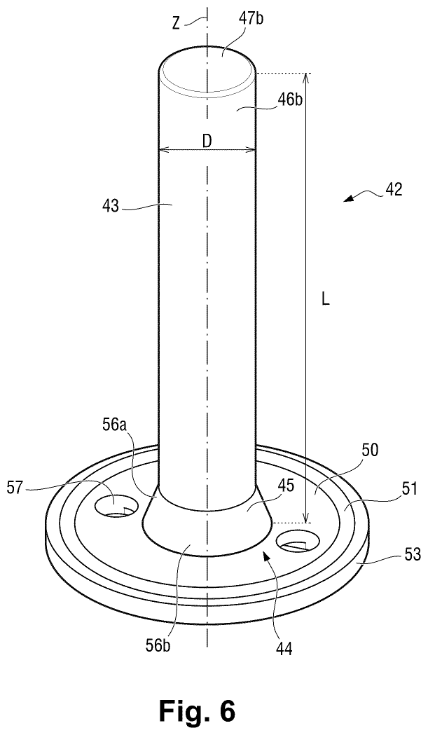

With reference to FIGS. 5 and 6, the pushbutton 42 comprises three separate parts:
an actuating member 43;
a base 44;
a diaphragm 45.

The actuating member 43, elongate in along an axis Z. The actuating member 43 here, is cylindrically-shaped with axis Z. The actuating member 43 has two ends: a first end 46a, at the end of which there is a face 47a, and a second end 46b, free, at the end of which there is a face 47b.

The term “elongate” is used here to mean that the length L of the actuating member 43 is greater than its diameter D. The length L is typically greater than 3×D, and even greater than 5×D.

The actuating member 43 is provided at the first face 47a of its first end 46a, of a first pad 48, electrically conductive, which covers a portion of the first face 47a. The first pad 48 here is made of carbon.

The base 44 of the pushbutton 42 is flexible and is in the shape of a flat disk having two opposite faces and a first hole 49 in its centre. The base 44 extends perpendicularly to the axis Z.

The base 44 comprises a first face 50 from which a flexible rib 51 extends, and a second face 52 which is intended to be pressed against the printed circuit 36. The rib 51 extends here at the periphery of the base 44, over its entire circumference.

The base 44 therefore, has an external perimeter 53, and the first hole 49 in the middle of the disc forms an inner perimeter 54 belonging to the base 44.

The pushbutton 42 exists in a plurality of versions, which differ by the number of second pads 55, electrically conductive, positioned on the second face 52 of the base 44 of the pushbutton 42. This number can be zero. The maximum number of second pads 55 is, for example, equal to five.

Here, the second face 52 of the base 44 is provided with three second conductive pads 55. These second conductive pads 55 here, are made of carbon.

The diaphragm 45 is an elastic element of the button 42, here forming a conical skirt, and having two ends, enabling to form the connecting element between the actuating member 43 and the base 44. A first end 56a of the diaphragm 45 is connected to the first end 46a of the actuator 43, and a second end 56b of the diaphragm 45 is connected to the first face 50 of the base 44, between the first hole 49 and the rib 51. Here, more precisely, the second end 56b of the diaphragm 45 is combined with the inner peri 54 of the base 44.

The diaphragm 45 thus connects the actuating member 43 to the base 44 to form the pushbutton 42. The three parts which form the pushbutton 42, namely the actuating member 43, the base 44 and the diaphragm 45, therefore, form a one-piece part.

In an advantageous manner, this one-piece part is made of a material capable of absorbing the vibrations caused during the operation of the speaker 10, and preferably of elastomer, whose elastic properties are more favorable than those of the materials of conventional buttons. The pushbutton 42 is therefore, significantly less rigid and brittle than the pushbuttons of the prior art.

As has been seen, the diaphragm 45 is elastic. Thus, when pressure is exerted on the second end 46b of the actuating member 43, the actuating member 43 undergoes a translational movement along its axis Z towards the base 44. The diaphragm 45 is deformed and the first end 46a of the actuating member 43 sinks into the first hole 49 of the base 44. When the pressure ceases, the actuating member 43 returns to its initial position.

The second end 46b of the actuating member 43 is accessible from outside the speaker 10. Consequently, the length L of the actuating member 43 is defined depending on the distance between the printed circuit 36 and the external surface of the speaker 10, to which is added the travel length for actuating the button 42. The length L of the actuating member 43 therefore, depends on the shape of the speaker 10. Here, the actuating member 43 has a length L equal to 24 mm. The travel length is equal to 1.5 mm. The total length of the button 42, along the axis Z, is equal to 25.5 mm.

The pushbutton 42 is provided with at least one evacuation device, here, two evacuation devices. The evacuation devices enable to evacuate air from an inner volume of the pushbutton 42 delimited by the diaphragm 45 and by a plane in which extends the second face 52 of the base 44. The two evacuation devices are positioned while being diametrically opposite relative to the first hole 49.

Each evacuation device comprises a second hole 57 passing through the base 44 and positioned between the second end 56b of the diaphragm 45 and the rib 51, and a duct 58 connecting the inner volume to said second hole 57.

When pressure is exerted on the second end 46b of the actuating member 43, the diaphragm 45 deforms, the inner volume decreases, and the air is evacuated by the evacuation devices. When the diaphragm 45 returns to its initial shape, air penetrates the inner volume via the evacuation devices.

Attention is now paid to the way in which the pushbutton 42 is integrated in the sound box 11 of the speaker 10.

The sound box 11 comprises an inner surface which has a hole 59 passing through the box 11, and a groove 60 which surrounds the hole 59 and which has a shape which is complementary to the rib 51 of the first face 50 of the base 44.

At the time of assembly, the pushbutton 42 is integrated in the box 11 such that the actuating member 43 extends into the hole 59, and the rib 51 of the base 44 is positioned in the groove 60 of the inner surface of the box 11. Then, the printed circuit 36 is installed such that the base 44 of the pushbutton 42 is located between the printed circuit 36 and the inner surface of the box 11, and parallel to these. The printed circuit 36 is fixed, here, by screwing to the inner surface of the box 11. The first face 50 of the base 44 of the pushbutton 42 is in contact with the inner surface of the b 11, and the second face 52 of the base 44 of the pushbutton 42 is in contact with the printed circuit 36. The printed circuit 36 presses on the second face 52 of the base 44, such that the rib 51 of the base 44 is crushed against the inner surface of the box 11, in the groove 60. This enables to ensure the acoustic sealing of the box 11. The second end 46b of the actuating member 43 is then accessible from the outside of the box 11.

In an advantageous manner, the groove 60 has the effect of contributing to the centering of the pushbutton 42.

However, the groove 60 is optional. In the case where the groove is not implemented, the rib 51 is configured to be crushed against a flat surface, which has the advantage of ensuring a better sealing.

Attention is now paid to the way in which the pushbutton 42 cooperates with the rest of the speaker 10.

The printed circuit 36 comprises a first contact device.

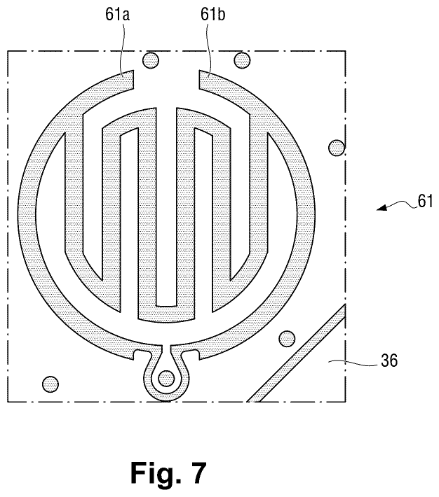

With reference to FIG. 7, the first contact device comprises here, a conductive track 61, printed on the printed circuit 36. The conductive track comprises here, two track portions 61a, 61b.

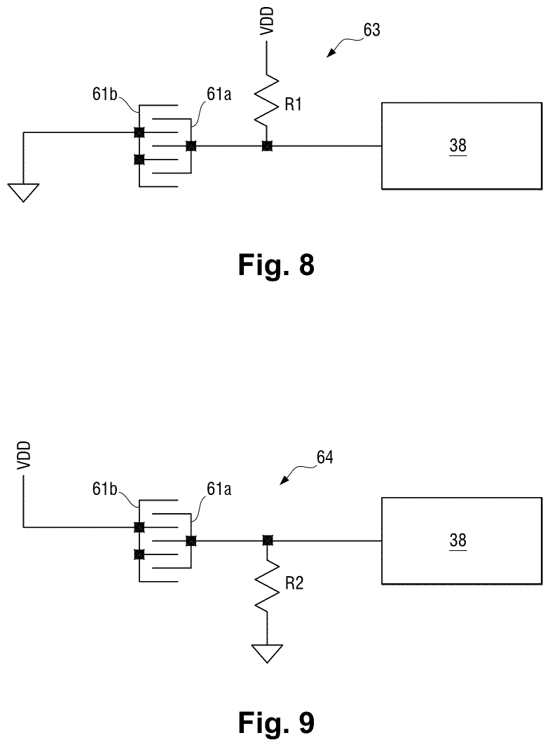

With reference to FIG. 8, the board 35 further comprises a detector circuit 63, which is connected to the processor unit 38 and to the conductive track 61. The detection circuit 63 comprises a resistor R1 (pull-up) which comprises a first terminal to which a DC power supply voltage VDD is applied and a second terminal connected to the track portion 61a. The track portion 61b is connected to the ground (or another reference voltage). The processing unit 38 is connected to the second terminal of the resistor R1.

The track portions 61a, 61b comprise “teeth” which are arranged according to a nested comb arrangement.

When the first pad 48 comes into contact with the track portions 61a, 61b, it short-circuits these track portions and the voltage applied at the input of the processing unit 38 goes from a “high” voltage to a “low” voltage, equal to 0V (or to the other reference voltage).

In a second embodiment, shown in FIG. 9, the detection circuit 64 comprises a resistor R2 (pull-down) which comprises a first terminal connected to the first track portion 61a and a second terminal connected to the ground (or to another reference voltage). The track portion 61b is connected to the DC power supply voltage VDD. The processing unit 38 is connected to the first terminal of the resistor R2.

When the first pad 48 comes into contact with the track portions 61a, 61b, the voltage applied as input to the processing unit 38 switches from a “low” voltage to a “high” voltage (VDD).

When the speaker 10 is assembled, the first detection device (and therefore, the two track portions 61a, 61b) is located in the first hole 49 of the base 44. When the user presses on the actuating member 43, the first pad 48 comes into contact with the track portions 61a, 61b, short-circuits them, and the processing unit 38 detects the change in voltage (on edge or level).

The processor unit 38 then controls the implementation of the predefined action.

The printed circuit 36 also comprises at least a second contact device, here for example, five second contact devices (not shown).

Each second contact device is possibly similar to the first contact device.

The five second contact devices are positioned on the printed circuit 36 to detect a maximum of five second conductive pads 55 possibly present on the second face 52 of the base 44 of the button 42.

It has therefore, been described, that the number of second contact devices is equal to the maximum number of second pads (here, equal to 5), which enables to detect the maximum number of combinations. The maximum number of second pads and second contact devices can be different from 5.

The maximum number of second pads and second contact devices depends on the size of the base 44 relative to the size of a second pad or a second contact device.

The maximum number of second pads and the number of second contact devices can be different.

Here, the base 44 comprises only three second pads 55, and therefore, only three second contact devices detect second conductive pads 55.

The processing unit 38 will then configure the speaker 10 depending on the number and/or the position of the second pads 55 detected. Here, only the number of second pads is taken into account.

The configuration of the speaker 10 here, consists in giving it a position in a multichannel audio system.

Here, the processing unit 38 detects the presence of three second pads 55. The processor unit 38 will interpret the presence of these three second pads 55 as a particular configuration order of the speaker 10 corresponding to a particular position in the multi-channel audio system (for example, rear left speaker).

If the number of the second pads 55 detected were different, the processing unit 38 would have configured the speaker 10 differently (for example, front-right, front-left, woofer, etc.).

It is noted that the pushbutton 42 and the printed circuit 36 or the box 11 possibly have positioning means for angular positioning the base 44 relative to the printed circuit 36, such that the positions of the second conductive pads 55 correspond to the positions of the second contact devices. These means comprise, for example, a lug on the inner surface of the box 11 and a hole on the base 44 which is accommodated in the lug.

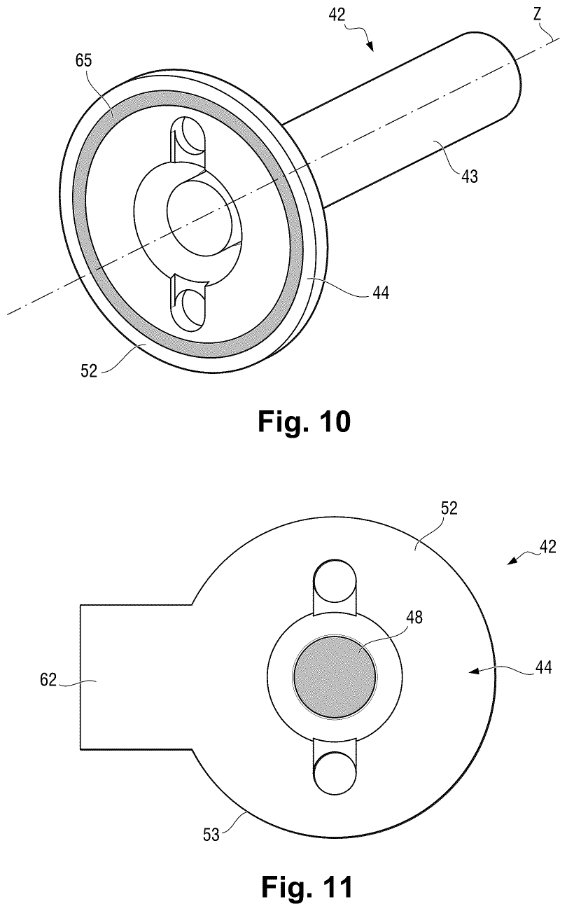

According to an alternative embodiment, shown in FIG. 10, the pushbutton 42 comprises at least one conductive ring 65 (here, only one) formed on the second face 52 of the base 44. The ring 65 is centred on the axis Z. Thus, the second contact device(s) of the printed circuit 36 can detect the presence or absence of the ring 65 regardless of the angular position of the pushbutton 42.

In a second embodiment shown in FIG. 11, the pushbutton 42 exists according to a plurality of versions that differ depending on the number and/or the position of protrusions 62. Here, only two versions of the button exist: a version of the button with a protrusion 62, and a version without protrusion 62.

FIG. 11 shows that the button 42 comprises a protrusion 62 that extends from the base 44, projected and radially, from the external perimeter 53 of the base 44 outward from it. This protrusion 62 belongs to the same part as the base 44 and the rest of the button 42, and is therefore, made here, of elastomer.

As for the printed circuit 36, it comprises at least one third detection device, here, a single third detection device (not shown). The third detection device comprises for example, a dome-shaped metal switch.

The processing unit 38 is connected to the third detection device. The processing unit 38 configures the speaker 10 depending on a number and/or the position of the detected protrusions.

Here, the processing unit 38 configures the speaker 10 according to a first configuration if a protrusion is detected, and according to a second configuration if no protrusion is detected.

Once again, the configuration can consist in giving the speaker 10 a position in a multichannel audio system.

There is now interest, more precisely, to the support 15 of the speaker 10.

It is known that, on the market, there are different types of speaker supports. Some supports only enable to place the speaker on a horizontal surface (for example, on a table) whereas other supports only enable to attach the speaker on a vertical surface (for example, wall mounting).

Nevertheless, a same support does not enable to position the speaker on a horizontal surface (for example, on a piece of furniture) or on a vertical surface (for example, against a wall).

There is therefore, a need to design a versatile speaker support, i.e. a single support capable of installing/fixing a speaker on different types of external supports (horizontal or vertical). In particular, the speaker support must fulfil the following two functions:
the so-called “table stand” function for positioning the speaker on a horizontal surface;
the so-called “wall mount” function for positioning the speaker on a vertical surface.

The support must also have a shape adapted to the capsule speaker and its curved external surfaces.

The support must ensure aesthetic coherence with the shape of the speaker, in particular, in the case of a capsule-shaped speaker, i.e. one having curved surfaces.

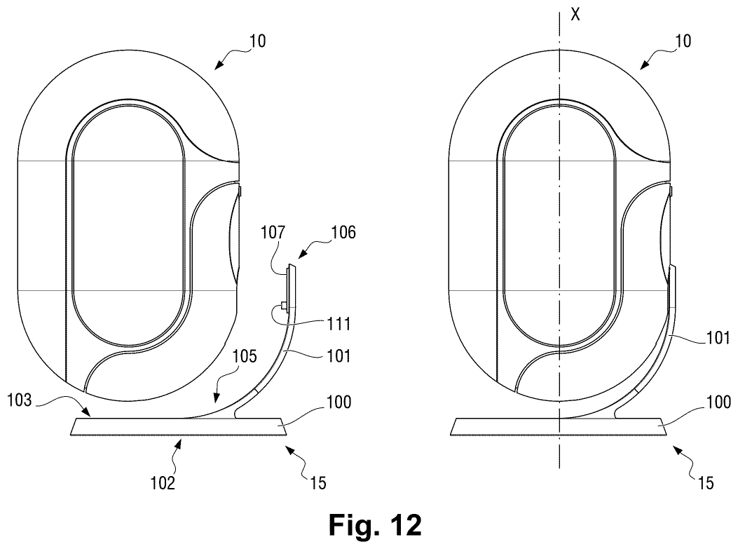

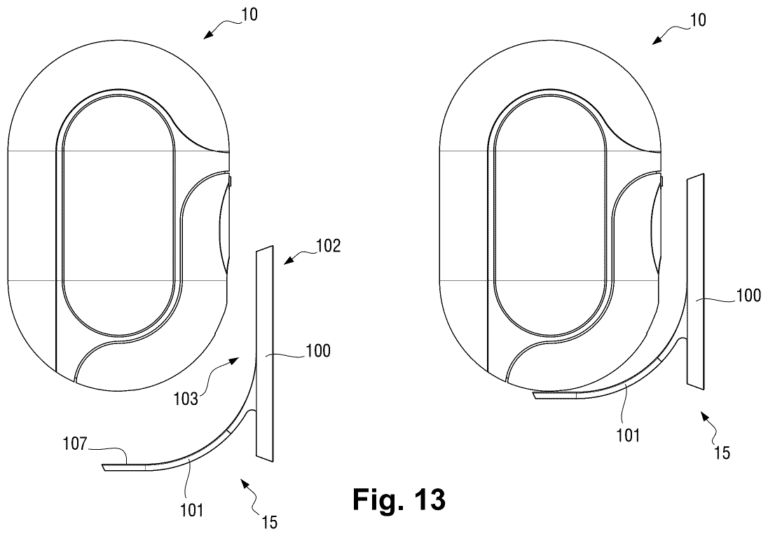

With reference to FIGS. 12 and 13, the support 15 of the speaker 10 comprises:
a base 100;
a curved portion 101.

The base 100 is generally flat-shaped and comprises a first face 102 and a second face 103. The first face 102 is intended to be in contact with an external support (for example, a table, a wall).

The curved portion 101 extends from the second face 103. The curved portion 101 comprises a first end 105 connected to the base 100 and a second free end 106. The curved portion 101 extends radially from the base 100 from its first end 105 to its second end 106.

Preferably, the curved portion 101 comprises a flat surface 107, oriented perpendicularly to the base 100, and comprising fastening means for fixing the flat surface 107 on a surface of the speaker 10. Here, the flat surface 107 of the curved portion 101 is located at the second end 106 of the curved portion 101.

FIG. 12 illustrates the first mounting configuration of the support on the speaker. This configuration is called “table stand”.

In this configuration, the first face 102 of the base 100 of the support 15 is placed on a flat horizontal surface (of a table, for example), and the fixing of the curved portion 101 to the speaker 10 is done from the rear of the speaker 10. The flat surface 107 is therefore, fixed to the rear face of the speaker 10.

FIG. 13 illustrates the second configuration for mounting the support 15 on the speaker 10. This configuration is called a “wall mount”.

In this configuration, the first face 102 of the base 100 of the support 15 is attached to the wall and the fixing of the curved portion 101 to the speaker 10 is carried out below the speaker 10. The flat surface 107 is therefore, fixed to the lower face of the speaker 10.

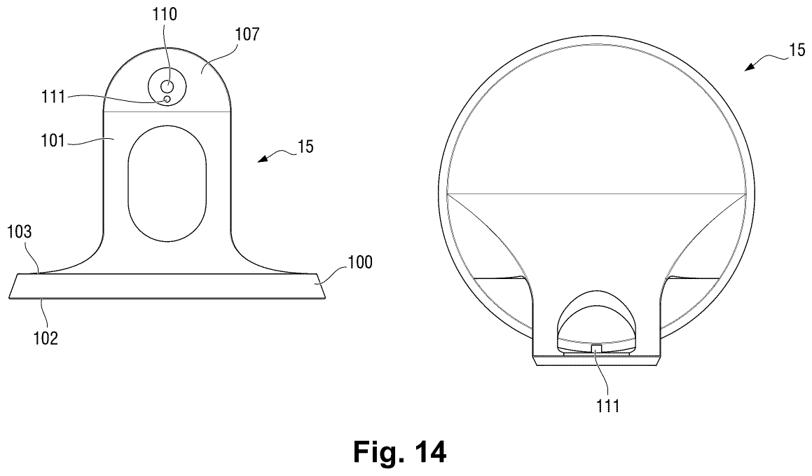

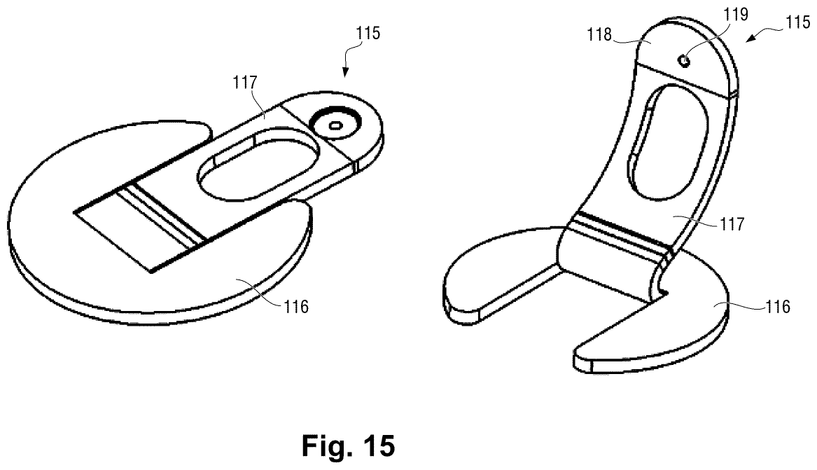

FIG. 14 shows front views of the support 15 in the “table stand” configuration (left drawing) and in the “wall mount” configuration (right drawing).

Preferably, the base 100 and the curved portion 101 of the support 15 are formed as one-piece (i.e. as a single part, for example, of aluminum).

For example, the surface of the base 100 is sized so as to ensure the stability of the speaker 10, when it is fixed to the curved portion 101 of the support 15, in particular in the “wall mount” configuration.

The base 100 comprises fastening means for fixing the support on a surface of the external support (for example, by screwing the support 15 on a wall). For example, these fastening means comprise one or more tapped holes formed in the thickness of the base and intended to receive a screw or knurled screw. These fastening means are not shown here.

The base 100 is arranged such that, when the speaker 10 and the support 15 are assembled, the axis of revolution X of the speaker 10 coincides with the centre of the base 100. Also, the surface of the base 100 of the support 15, in contact with the table, is sized such that the projection of the centre of gravity of the speaker 10 is fits within said surface.

Preferably, the curved portion 101 has a bend radius greater than the bend radius of the curved external surface of the capsule speaker 10, such that the curved portion 101 follows the curved shape of the speaker 10 without, however, risking of coming into contact with it.

The flat surface 107 of the second end 106 of the curved portion 101 comprises fastening means for fixing the support to the speaker, either to the rear face of the speaker according to the first mounting configuration, or to the lower portion of the speaker according to the second mounting configuration. The fastening means comprise for example, one or more holes or openings 110, each intended to receive a screw or knurled screw. Here, the fastening means comprise a single tapped hole 110.

Consequently, the capsule speaker 10 comprises one or more tapped holes arranged opposite the hole(s) or openings 110 of the flat surface 107.

The flat surface 107 of the second end 106 of the curved portion 101 further comprises a lug 111, shown in FIG. 12 and in FIG. 14. This lug 111 is intended to be inserted into a hole (not shown) formed on one face of the speaker 10, so as to secure the speaker 10 in its vertical position when it is fixed to the support. Thus, there is no risk of the speaker 10 pivoting about the screw passing through the opening 110 formed through the flat surface 107 of the curved portion 101. This is advantageous during the step of fixing the speaker 10 to its support 15 (i.e. during installation), but also prevents the speaker 10 from pivoting due to the vibrations emitted during the operation of the speaker 10.

Here, the curved portion 101 has a thickness of between 3 mm and 6 mm, preferably 5 mm. Thus, the support 15 is sufficiently robust to maintain the speaker 10 vertically and to prevent it from tilting under the effect of its weight, and without causing oscillations to the speaker 10 on the support when a user manipulates it or due to the vibrations emitted during operation.

It is possible to make the curved portion 101 from plastic. However, there is a risk that the support 15 of the speaker 10 is not rigid enough and vibrates with the speaker 10.

To improve the rigidity of the support and to limit the vibrations of the speaker/support when the speaker 10 is operating, several embodiments are advantageous.

In a first embodiment, the curved portion 101 is made of metal (for example, aluminum) rather than plastic. In a particular embodiment, the entire support is made of metal, for example, the same metal as that used for the base 100 (for example, aluminum), in which case, the support 15 is a one-piece part of metal (which has the advantage of being robust and limiting vibrations compared to plastic).

In a second embodiment, the curved portion 101 is made of plastic but further comprise, a rib on the back of the curved portion. In a particular embodiment, the entire part is made of plastic, preferably in a one-piece, in which case the rib can be easily formed in the curved portion 101.

In a third embodiment, shown in FIG. 15, the support 115 can be made from a folding of a metal plate cutout (for example, aluminum). Advantageously, the support 115 is formed of a single part.

The left drawing of FIG. 15 shows the support 115 before the folding, and the right drawing shows the support 115 after the folding. Once again, the support 115 comprises a base 116 and a curved portion 117 having at its free end a flat surface 118, provided with a fixing hole 119, on which the speaker is fixed.

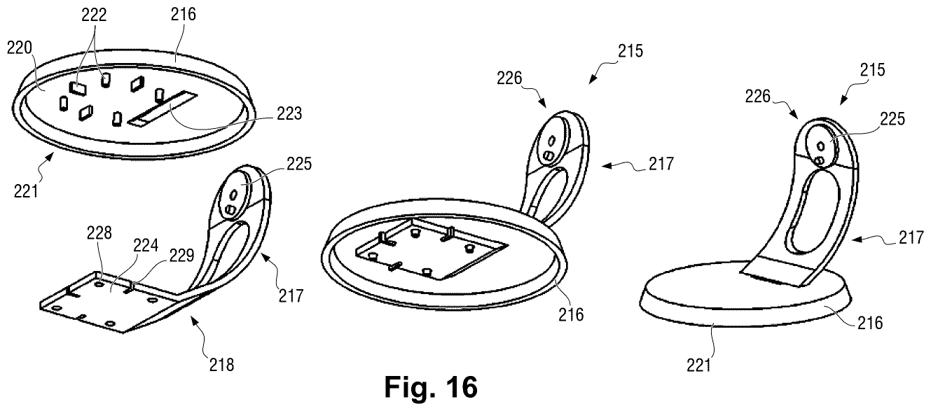

In a fourth embodiment, shown in FIG. 16, the support 215 can be split into two separate parts. By way of example, the support 215 then comprises a plastic stand 216 (the base) and a curved portion 217 made of metal. The first end 218 (tab) of the curved portion 217, made of metal (for example, aluminium), is headed onto the bottom 220 of the first face 221 of the base.

The heading is particularly advantageous for attaching the curved portion 217 onto the base 216 for the same reasons as previously indicated (i.e no additional parts, no risk of vibration, reduced bulk, very robust connection). The plastic pins 222 extend vertically from the bottom 220 of the first face 221 of the base 216. The base 216 also comprises a slot 223.

The first end 218 of the curved portion 217 comprises a flat surface 224, that extends orthogonally to the flat surface 225 of the second end 226 of the curved portion. The flat surface 225 has the shape of a circular pad. The flat surface 224 comprises holes 228, and slots 229 formed in the edges of the flat surface 224. Here, the flat surface 224 is square-shaped; the holes 228 are located in the corners of the flat surface 224 and the slots 229 are located at the midpoints of the three free edges of the flat surface 224.

The flat surface 224 is inserted into the slot 223 and then applied against the bottom 220 of the first face 221 of the base 216, such that the pins 222 are inserted into the holes 228 and the slots 229. The flat surface 224 is then fixed by heading at the bottom 220 of the first face 221 of the base 216.

Naturally, the invention is not limited to the embodiments described, but comprises any variant entering into the scope of the invention such as defined by the claims.

Although the actuating member here, is cylindrically-shaped, it is possible for it to be of some other shape.

Although here, the base of the button is described as having a disc shape, it is possible that it has another shape, rectangular for example.

Although the diaphragm is described as having a conical skirt shape, it is possible that this diaphragm has a different shape: pyramidal, formed by flexible rods, by a spring, etc.

The first end of the actuating member is not necessarily provided with a conductive pad. The actuating member could, for example, cooperate “mechanically” with a first “mechanical” contact device, and for example, a with mechanical switch. The interaction with the printed circuit could also be a contactless interaction (for example, capacitive).

The base of the button could be provided with both conductive pad(s) and/or protrusion(s) and/or ring(s)

The pushbutton is not necessarily integrated in the sound box of a speaker. It could be integrated in a casing of any type of electrical equipment and this, regardless of the shape of said casing.

1. A pushbutton, comprising:
an actuating member, of elongate shape along an axis;
a base, flexible and generally flat in shape, that extends perpendicularly to the axis, and that comprises a first hole and a rib that extends from a first face of the base around the first hole;
an elastic diaphragm, having a first end connected to a first end of the actuating member and a second end connected to the first face of the base between the first hole and the rib;
the pushbutton being arranged in such a manner that, when pressure is exerted on a second end of the actuating member, the diaphragm deforms and the actuating member undergoes a translational movement along the axis towards the base, and in such a manner that, when the pressure ceases, the actuating member returns to its initial position,
the pushbutton further comprising, at least one evacuation device enabling to evacuate air from an inner volume of the pushbutton delimited by the diaphragm and by a plane in which extends a second face of the base, the evacuation device comprising a second hole passing through the base and positioned between the second end of the diaphragm and the rib, and a duct connecting the inner volume to the second hole.

2. The pushbutton according to claim 1, comprising a first pad, electrically conductive, which is positioned on a face of the first end of the actuating member.

3. The pushbutton according to claim 1, comprising at least a second pad, electrically conductive, which is positioned on the second face of the base.

4. The pushbutton according to claim 1, comprising at least one ring electrically conductive, which is positioned on a second face of the base and which is centred on the axis.

5. The pushbutton according to claim 1, comprising at least one protrusion that extends from the base, radially outward from it.

6. The pushbutton according to claim 1, wherein the actuating member, the base and the diaphragm form a one-piece part made of elastomer.

7. An equipment comprising a casing, a printed circuit integrated in the casing, fixed to an inner surface of the casing, and on which is located a first contact device, and a pushbutton according to claim 1, which is also integrated in the casing, the equipment being arranged such that the base of the pushbutton is located between the printed circuit and the inner surface of the casing, the first face of the base is in contact with said inner surface of the casing and a second face of the base is in contact with the printed circuit, the printed circuit presses on the second face of the base such that the rib is crushed against the inner surface of the casing, the first contact device is positioned in the first hole of the base, the actuating member extends through the casing, and a second end of the actuating member is accessible from the outside of the casing such that when pressure is exerted on the second end of the actuating member, the diaphragm deforms and the first end of the actuating member comes into contact with the first contact device, and such that when the pressure ceases, the actuating member returns to its initial position, the equipment further comprising, a processing unit connected to the first contact device and arranged to control a predefined action when the first end of the actuating member comes into contact with the first contact device.

8. The equipment according to claim 7, the inner surface of the casing comprising a groove in which the rib of the first face of the base of the pushbutton is positioned.

9. The equipment according to claim 7, wherein the pushbutton comprises a first pad. electrically conductive, which is positioned on a face of the first end of the actuating member, the first contact device comprising at least two conductive track portions printed on the printed circuit, the first pad being arranged to short-circuit the two conductive track portions when the first end of the actuating member comes into contact with the two conductive track portions.

10. The equipment according to claim 7, the printed circuit comprising at least a second contact device arranged to detect at least a second pad electrically conductive which is optionally present on a second face of the base of the pushbutton, the processing unit being arranged to configure the equipment depending on a number and/or a position of the detected second pads.

11. The equipment according to claim 7, the printed circuit comprising at least one third contact device arranged to detect at least one protrusion, optionally present by extending from the base of the pushbutton, radially, outward from it, the processing unit being arranged to configure the equipment depending on a number and/or a position of the detected protrusions.

12. The equipment according to claim 7, the equipment being a speaker.

13. The equipment according to claim 10, wherein the equipment is a speaker, the configuration of the speaker consisting in giving it a position in a multi-channel audio system.

14. The equipment according to claim 11, wherein the equipment is a speaker, the configuration of the speaker consisting in giving it a position in a multi-channel audio system.
